(19) United States
(12) Patent Application Publication
(10) Pub. No.: US 2006/0106630 A1
(43) Pub. Date: May 18, 2006

(54) Utilization of visual auxiliary inspection devices for vehicle servicing system and method

(76) Inventor: Wang-Ying Lo, Miaoli City (TW)

Correspondence Address: J.C. Patents, Suite 250, 4 Venture, Irvine, CA, 92618, US

(21) Appl. No.: 10/991,698

(22) Filed: Nov. 17, 2004

(51) Int. Cl. G06Q 99/00

(52) U.S. Cl. 705/1

(57) ABSTRACT

A utilization of visual auxiliary inspection devices for vehicle servicing system and method, with an image take-up and recorder sensing head of a visual inspection device to display the image on a liquid crystal display, capable of using a digital multimedia audiovisual storage facility and the Internet or directly providing the servicing personnel or the customer with the inspection results, to make servicing easier, more efficient servicing and inspection operation, the servicing system includes: a braking system, an air conditioning circulation system, an engine cooling system, a steering control system, a chassis carrier system, a car parts system, a fuel intake system, and an engine exterior system. The method includes the following steps: establishment of a servicing and inspection databank to process the servicing response system data, the inspection operation shall display the inspection results for conducting a servicing response system operation according to the inspection results, to increase the customer's confidence and enhance the transparency of the transaction, to achieve effective communication of information, increase working efficiency and reduce costs, increase the efficiency of the car servicing operation and reduce the time for the troubleshooting process.

### BACKGROUND OF THE INVENTION

1. Background of the Invention

The present invention relates to the utilization of visual auxiliary inspection devices for vehicle servicing system and method, particularly the use of visual auxiliary devices in a vehicle servicing system and method to obtain high efficiency, convenience and transparency in operational procedures.

2. Description of the Prior Art

To keep in line with rapid changes in our environment with the advent of the high-tech era, enterprises have become more and more aware of the demand for electronic products. Only the most efficient, simplified and convenient servicing operation for vehicles can contribute competitiveness to the enterprise and more transparency in the servicing of vehicles to individual persons. In the past, even when the enterprise or individual has provided information on inspection and servicing of vehicles to customers, they could not gain a full understanding of the actual progress in the inspection and servicing process, or gain an analysis of all servicing items. Therefore, due to the inconsistency in the service personnel's servicing skills and quality, there has been a high frequency of disputes and customer complaints over the servicing of their vehicles, bringing much trouble and difficulty to our society.

### SUMMARY OF THE INVENTION

In view of seeking a solution to the foregoing problem, the present inventor has come up with a utilization of visual auxiliary inspection devices for vehicle servicing system and method, with the main objective to utilize visual auxiliary inspection devices in the servicing system, including: the braking system, air conditioning and circulation system, engine cooling system, steering control system, chassis carrier system, car parts system, fuel intake system and engine exterior system. The second objective is to utilize visual auxiliary inspection facilities, auxiliary inspection consultants and servicing technicians to reduce their operating time in conducting inspection of vehicle conditions and how parts and components are worn, to allow customers to see how the parts are damaged by means of facilities and monitors. Meanwhile, the inspection consultants and servicing technicians will suggest to customers what types of servicing to choose and what car chemicals to use to maintain their vehicles in the best working conditions. Using the inspection devices, the auxiliary inspection consultants and servicing technicians will provide customers with an immediate explanation of conditions of the car under rapid inspection in regular servicing programs, thereby reducing time and increasing accuracy in troubleshooting processes.

### BRIEF DESCRIPTION OF THE DRAWINGS

The other objects and features of the present invention can be more fully understood by referring to the following description of preferred embodiments and accompanying drawing, in which:

FIG. 1 is a system skeleton chart of a utilization of visual auxiliary inspection devices for vehicle servicing system and method of the present invention.

FIG. 2 is a perspective view of the inspection device of the present invention.

FIG. 3 is a main flowchart of the operation in the present invention of a utilization of visual auxiliary inspection devices for vehicle servicing system and method

### DETAILED DESCRIPTION OF THE PREFERRED EMBODIMENT

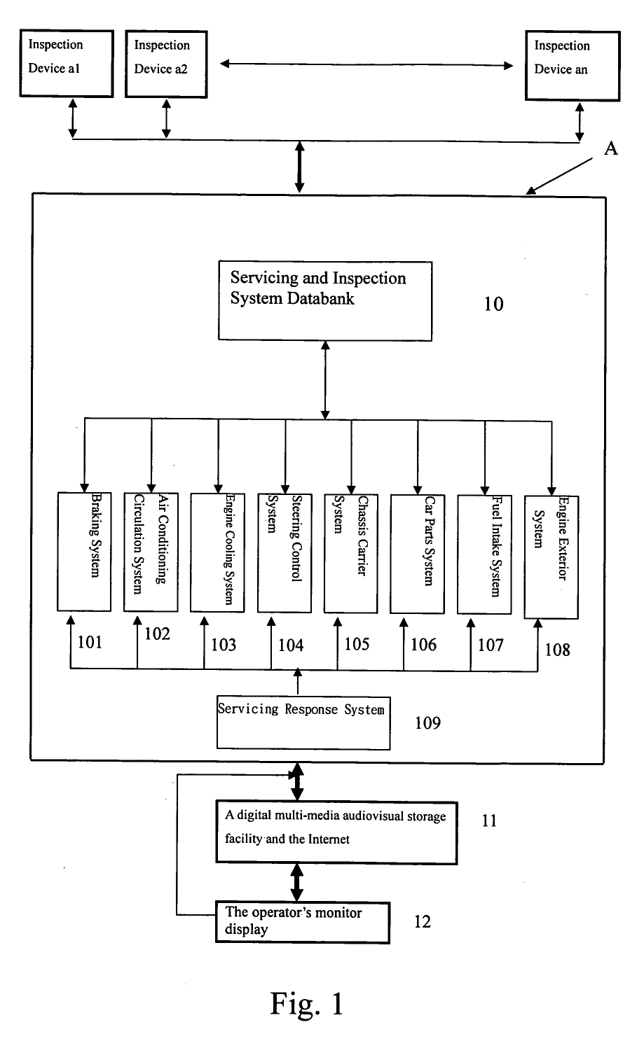

The present invention relates to a utilization of visual auxiliary inspection devices for vehicle servicing system and method. FIG. 1 shows a skeleton chart of the servicing and inspection. An enterprise's servicing uses several inspection devices a1, . . . an, aimed at the servicing inspection system databank 10 provided in the servicing and inspection system 1, engaged in mutual communication with the operator's display 12 by means of digital multi-media audiovisual storage facilities and the Internet 11, or directly shown on the operator's display 12, to further achieve the objectives of concentration, management, analysis and assessment, to solve various problems a business may face in its servicing and inspection on mass products.

First, the inspection devices a1, . . . an shall set up (1) servicing inspection system databank 10 according to the servicing inspection system: the servicing and inspection shall be conducted on vehicles, including a braking system 101, an air conditioning circulation system 102, an engine cooling system 103, a steering control system 104, a chassis carrier system 105, a vehicle parts system 106, a fuel intake system 107, an engine exterior system 108 and a servicing response system 109, as shown in FIG. 1, of which the servicing and inspection system databank 10 includes data concerning servicing and inspection as follows:
(1) Servicing and inspection for braking system 101 includes: 1. Inspection of thickness of brake lining 1011; 2. Inspection of levelness of brake disc 1012; 3. Inspection of oil leak in master brake pump 1013; 4. Inspection of oil leak in slave brake pump 1014; 5. Inspection of oil leak and cracking in hypertension brake pipe 1015; as shown in Table (1).
(2) Servicing and inspection for air conditioning circulation system 102 includes: 1. Inspection of the leak in the heat radiator 1021; 2. Inspection of damage and leak in the air compressor 1022; 3. Inspection of the leak in the liquid storing bottle; 4. Inspection of leak, blocking and cleanness of evaporator 1024; 5. Inspection of leak in connector of high/low pressure piping 1025; as shown in Table (1).
(3) Servicing and inspection for the engine cooling system 103 includes: 1. Inspection of cooling water tank 1031; 2. Inspection of water leak in cooling water circulation pump 1032; 3. Inspection of oxidization, corrosion and leak in cooling water pipe 1033; 4. Inspection of all water pipe joints and hot water iron pipes 1034; as shown in Table (1).
(4) Servicing and inspection for the steering control system 104 includes: 1. Inspection of anti-dust cover on steering main unit 1041; 2. Inspection of oil leak in driving pump 1042; 3. Inspection of wear on pull lever of the steering mechanism 1043; as shown in Table (1).
(5) Servicing and inspection for chassis carrier system 105 includes: 1. Inspection of the crack in the carrier triangle rubber 1051; 2. Inspection of damage on iron sleeve 1052; 3. Inspection of damage on ball joint 1053; 4. Inspection of damage in shock absorption assembly 1054; 5. Inspection of damage in all components of torsion rod 1055; as shown in Table (2).
(6) Servicing and inspection for vehicle parts system 106 includes: 1. Checking on parts and supply codes 1061; 2. Comparison of appearances of parts 1062; 3. Long-distance transmission of actual images 1063; 4. Spot assessment of damage 1064; 5. Inspection of operation of power-driven window elevator 1065; 6. Observation and verification of engine and car body codes 1066; 7. Servicing and inspection of damage in car bodywork and car door locks and fasteners 1067; as shown in Table (2).

(7) Servicing and inspection for fuel intake system 107 includes: 1. Inspection of exterior of fuel piping 1071; 2. Inspection of deposited carbon on intake bypass tube 1072; 3. Inspection of deposited carbon on throttles 1073; 4. Assessment and report on cleaning 1074; 5. Inspection of deposited carbon

TABLE (1)
Braking System 101
1. Inspection of thickness of brake lining 1011
2. Inspection of levelness of brake disc 1012
3. Inspection of oil leak in master brake pump 1013
4. Inspection of oil leak in slave brake pump 1014
5. Inspection of oil leak and cracking in hypertension brake pipe 1015
Air Conditioning Circulation System 102
1. Inspection of leak in the heat radiator 1021
2. Inspection of damage and leak in the air compressor 1022
3. Inspection of leak in the liquid storing bottle
4. Inspection of leak, blocking and cleanness of evaporator 1024
5. Inspection of leak in connector of high/low pressure piping 1025
Engine Cooling System 103
1. Inspection of cooling water tank 1031
2. Inspection of water leak in cooling water circulation pump 1032
3. Inspection of oxidization, corrosion and leak in cooling water pipe 1033
4. Inspection of all water pipe joints and hot water iron pipes 1034
Steering control system 104
1. Inspection of anti-dust cover on steering main unit 1041
2. Inspection of oil leak in driving pump 1042
3. Inspection of wear on pull lever of the steering mechanism 1043;
4. Inspection of anti-dust cover of transmission shaft 1044
5. Inspection of high/low-pressure piping of power pump 1045

on intake and exhaust valves 1075; 6. Inspection of deposited carbon in combustion chamber and pistons 1076; 7. Inspection of wear on cylinder wall; as shown in Table (2).
(8) Servicing and inspection of the engine exterior system 108 includes: 1. Inspection of oil leak in oil seal and packing 1081; 2. Inspection of clogging of cooling water and rust corrosion 1082; 3. Inspection of cracking and wear in all driving belts 1083; 4. Inspection of oil sludge in rocker arm chamber 1084; 5. Inspection of oil sludge and components in crankshaft box 1085; 6. Inspection of belt at ignition time and belt of balance shaft and components 1086; 7. Inspection of cleanness of engine exterior 1087; as shown in Table (3).

(9) Servicing response items of servicing response system 109 include: 1. Recommendation to customer in the use of cleansing agents for brake parts and noise-removing agents 1091; 2. Recommendation to customer in the use of cleansing agents for evaporators and lubricator for air compressor 1092; 3. Recommendation to customer in the use of cleansing agent for cooling system, anti-refrigerant for water tank and anti-leak agent for water tank 1093; 4. Recommendation to customer in the replacement of oil and use of anti-leak agent for power steering mechanism 1094; 5. Recommendation to customer in the use of jet-spray type lubricating grease 1095; 6. Recommendation to customer in the use of lubricating and protective agent for power-driven windows and jet-spray type lubricating grease 1096; 7. Recommendation to customer in the use of cleansing agent for deposited carbon in combustion chamber and moisture eliminator for fuel system and cleansing agent for oil spray nozzle and addition of engine lubricant and anti-wear agent 1097; 8. Recommendation to customer in the use of anti-leak agent for engine and cleansing agent and rubber protective agent for engine exterior and protective agent for belt and cleansing agent for oil sludge in

TABLE (2)
Chassis Carrier System 105
1. Inspection of crack in the carrier triangle rubber 1051
2. Inspection of damage on iron sleeve 1052
3. Inspection of damage on ball joint 1053
4. Inspection of damage in shock absorption assembly 1054
5. Inspection of damage in all components of torsion rod 1055;
Vehicle Parts System 106
1. Checking on parts and supply codes 1061
2. Comparison of appearances of parts 1062
3. Long-distance transmission of actual images 1063
4. Spot assessment of damage 1064
5. Inspection of operation of power-driven window elevator 1065
6. Observation and verification of engine and car body codes 1066
7. Servicing and inspection of damage in car bodywork and car door locks
and fasteners 1067
Fuel Intake System 107
1. Inspection of exterior of fuel piping 1071
2. Inspection of deposited carbon on intake bypass tube 1072
3. Inspection of deposited carbon on throttles 1073
4. Assessment and report on cleaning 1074
5. Inspection of deposited carbon on intake and exhaust valves 1075
6. Inspection of deposited carbon in combustion chamber and pistons 1076
7. Inspection of wear on cylinder wall 1077

engine chamber 1098; as shown in Table (3).

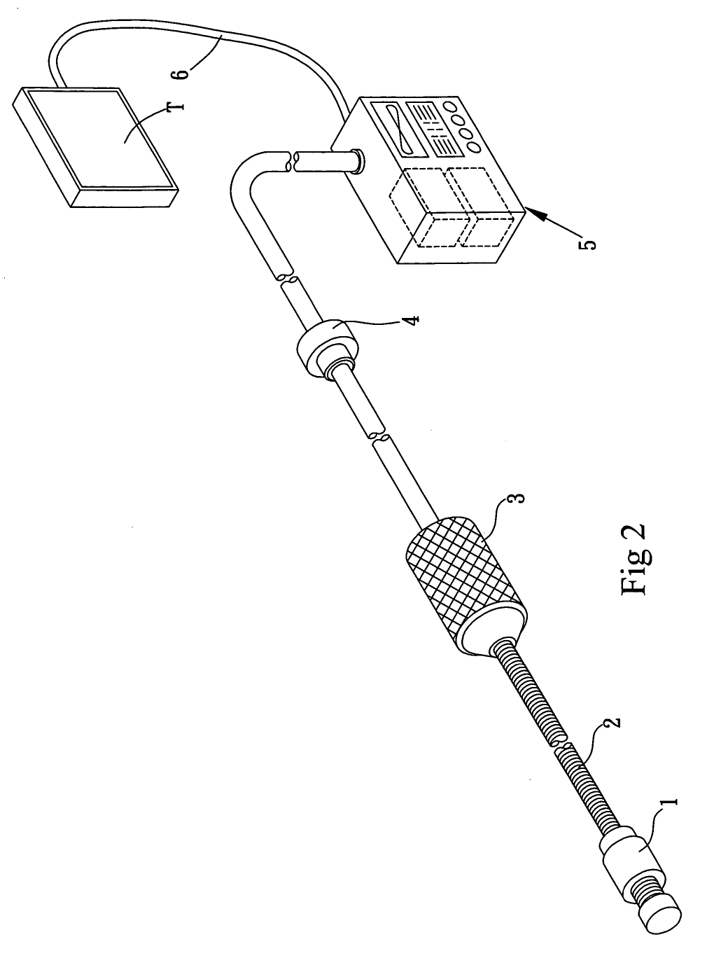

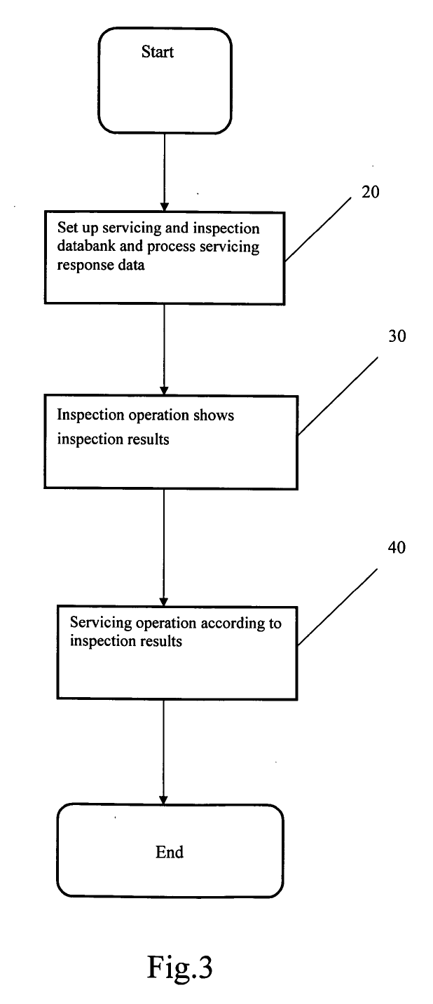

Furthermore, as shown in FIG. 2, the visual auxiliary inspection device consists of an image take-up video recorder sensing head 1, a flexible tube 2, a handle 3, an image IC board device 4, an inspector main unit 5, and a liquid crystal display T. As shown in FIG. 1, the foregoing servicing and inspection system 1 uses the monitor main unit 5 in the inspection device 1′ to control the image take-up video recorder sensing head 1, and transmit the signals via the image IC board device 4 to the liquid display T to show the images. As shown in FIG. 3 that shows the main flowchart of the present invention of the servicing system using the inspectors and the operation of its methodology, the steps to be adopted in the present invention are as follows:
1. Set up a servicing inspection system databank to process servicing related system data 20.
2. Display the result 30 according to the inspection operation in Step 1.
3. Conduct related servicing operation 40 according to the inspection results.

Please refer to FIGS. 1 and 3. The servicing inspection operation of an enterprise can be transmitted through a digital multi-media audiovisual storage facility and the Internet 11 to the monitor display 12 of respective operators, or the operator's monitor display 12 can directly display the results of the servicing related system 109, and make responses according to the steps shown in FIG. 3. Such servicing and inspection operation will not only convince the customers via “seeing is believing” and transparent explanations, and will also integrate the data of all inspection devices, to enable proper control of each customer's car, saving much labor costs and minimizing human errors, to enhance vehicle servicing and maintenance.

The present invention of a utilization of visual auxiliary inspection devices for vehicle servicing system and method has met the requirements for a patent right, therefore this application is duly filed.

```
TABLE (3)
Engine Exterior System 108
1. Inspection of oil leak in oil seal and packing 1081
2. Inspection of clogging of cooling water and rust corrosion 1082
3. Inspection of cracking and wear in all driving belts 1083
4. Inspection of oil sludge in rocker arm chamber 1084
5. Inspection of oil sludge and components in crankshaft box 1085
6. Inspection of belt at ignition time and belt of balance shaft and
  components 1086
7. Inspection of cleanness of engine exterior 1087
Servicing Response System 109
1. Recommendation to customer in the use of cleansing agents for brake
  parts and noise-removing agents 1091
2. Recommendation to customer in the use of cleansing agents for
  evaporators and lubricator for air compressor 1092
3. Recommendation to customer in the use of cleansing agent for cooling
  system, anti-refrigerant for water tank and anti-leak agent for water
  tank 1093
4. Recommendation to customer in the replacement of oil and use of
  anti-leak agent for power steering mechanism 1094
5. Recommendation to customer in the use of jet-spray type lubricating
  grease 1095
6. Recommendation to customer in the use of lubricating and protective
  agent for power-driven windows and jet-spray type lubricating
  grease 1096
7. Recommendation to customer in the use of cleansing agent for
  deposited carbon in combustion chamber and moisture eliminator for
  fuel system and cleansing agent for oil spray nozzle and addition of
  engine lubricant and anti-wear agent 1097
8. Recommendation to customer in the use of anti-leak agent for engine
  and cleansing agent and rubber protective agent for engine exterior and
  protective agent for belt and cleansing agent for oil sludge in engine
  chamber 1098
```

What is claimed is:

1. A utilization of visual auxiliary inspection devices for vehicle servicing system, comprising a specified number of inspection devices to directly display the results of inspection from an image take-up video recorder sensing head on an operator's monitor display, or to transmit the results through a digital multi-media audiovisual storage facility and the Internet onto the operator's monitor display, so that customers are capable of knowing the inspection results and countermeasures, the servicing and inspection system comprising: a braking system, an air conditioning circulation system, an engine cooling system, a chassis carrier system, a car parts system, a fuel intake system, an engine exterior system and a servicing response system.

2. A servicing system of claim 1, wherein the operator's monitor display is optionally one of the following digital equipment: a personal computer, a notebook computer and a mobile phone.

3. A servicing system of claim 1, wherein the Internet includes a cable network and wireless network.

4. A utilization of visual auxiliary inspection devices for vehicle servicing method, using a digital multi-media audiovisual storage facility and the Internet, directly providing a user with the ability to use an operator's monitor display to conduct a servicing and inspection operation on one device or facility, the method including the following steps: establishment of a servicing and inspection databank to process servicing response system data; inspection operation and display of inspection results; and conducting of servicing response system and servicing operation according to the inspection results.

5. A servicing method of claim 4, wherein the operator's monitor display is one of the following digital devices: a personal computer, a notebook computer and a mobile phone.

6. A servicing method of claim 4, wherein the servicing response system data described in the steps refers to all countermeasures in the servicing system.

7. A servicing method of claim 4, wherein the Internet includes cable network and wireless network.
